(19) United States
(12) Patent Application Publication
(10) Pub. No.: US 2020/0279182 A1
(43) Pub. Date: Sep. 3, 2020

(54) METHOD AND SYSTEM FOR AUTOMATICALLY PRODUCING PLAIN-TEXT EXPLANATION OF MACHINE LEARNING MODELS

(71) Applicant: FLOWCAST, INC., Burlingame, CA (US)

(72) Inventors: Kenneth SO, Burlingame, CA (US); Kathryn RUNGRUENG, San Francisco, CA (US); James Patrick McGUIRE, Cedar Glen, CA (US); Alex KELLER, Waterloo (CA)

(21) Appl. No.: 16/806,882

(22) Filed: Mar. 2, 2020

Related U.S. Application Data
(60) Provisional application No. 62/812,997, filed on Mar. 2, 2019.

(51) Int. Cl. G06N 5/04; G06N 20/00; G06F 40/205

(52) U.S. Cl. CPC G06N 5/045; G06F 40/205; G06N 20/00

(57) ABSTRACT

Embodiments provide methods and systems for generating a plain-text explanation for a prediction score associated with a record. An explanation generation system is configured to receive the record from a user. A prediction score is calculated using an ML model and a plurality of feature variables that are contributing to the prediction score are determined by the system. The plurality of feature variables are rank-ordered by the system based on their corresponding contribution to the prediction score. Further, correlated features are determined from among the plurality of feature variables and are grouped into one or more groups of correlated feature variables. At least one feature variable from each of the one or more groups is selected to determine a list of feature variables. The list of feature variables is passed to a sentence creation module that generates a plain-text explanation. The generated plain-text explanation is displayed to the user.

### TECHNICAL FIELD

Embodiments of the disclosure generally relate to the field of artificial intelligence and machine learning models. Embodiments relate more particularly to a method and system to generate statements that are easy to understand and generalized across multiple models or domains.

### BACKGROUND

Decisions are related to reasoning. Human decisions are often biased and unpredictable whether intentional or subconscious. On the other hand, computerized algorithms such as Artificial Intelligence (AI) and Machine Learning (ML) models are deterministic, auditable, reproducible and tuneable. Further, humans are prone to burnout and can easily miss things. With the capabilities of AI, including the speed and accuracy of data aggregation and analysis, there is certainly a compelling case of using it in business decision making.

Artificial Intelligence (AI) is a field of computer science that attempts to simulate characteristics of human intelligence or senses. These include learning, reasoning and adapting. AI's main purpose is to make people's lives easier and help reduce the number of mistakes made by the humans.

Machine Learning is a category of algorithms that produces more accuracy in predicting outcomes without being explicitly programmed Certain domains such as finance and healthcare require additional insight into ML algorithms due to their complexity and the need for clarity in prognoses. For instance, a prediction of deceased life expectancy considering a patient's health data is not as useful as knowing the reasons for the prediction and the steps to reverse and improve the predicted outcome. Simple algorithms such as logistic regression is part of a family of linear models and are globally explainable, with coefficients detailing the marginal impact of each input. For linear models, the marginal impact of the inputs on every prediction is the same globally. However, with the recent speed-up gains of processing big-data on distributed computers, ML models have become increasingly complex and highly non-linear to maximize predictive performance at the cost of increased opaqueness. ML models such as neural networks, random forests, support vector machines, and gradient boosted trees produce highly non-linear decision boundaries in the feature-space, where features non-linearly impact the prediction globally.

End users would always prefer solutions that can be easily interpreted and are understandable. The interpretability of data and machine learning models is critical. Current explanation methods, such as local linear approximations (LIME), do not provide an intuitive understanding of the predictions being made. SHAP uses Shapley values which improve on the linear approximation, but are not easier to understand than LIME. LIME and SHAP are more general frameworks that aim to make the predictions of any machine learning model more interpretable.

Existing methods produce ranked lists of important features but are difficult to understand by end-users such as consumers and risk-teams. Currently, there are no methods to help end-users understand the predictions computed across multiple models or domains.

In light of the above discussion, there appears to be a need for a method to create plain-text statements that are easy to understand and that generalize across multiple models or domains.

### SUMMARY

In an embodiment, a computer-implemented method generating a plain-text explanation for a prediction score associated with a record is disclosed. The method includes receiving, by a processor of an explanation generation system, a record, wherein the record is input by a user on the explanation generation system. The method includes determining, by the processor, a plurality of feature variables contributing to the prediction score associated with the record, the prediction score computed by a Machine Learning (ML) model. The ML model may utilize one or more predictive algorithms. The method further includes ranking, by the processor, the plurality of feature variables based at least on corresponding contribution of feature variables on the prediction score associated with the record. The method includes determining, by the processor, one or more groups of correlated feature variables from among the plurality of feature variables. The method includes filtering, by the processor, at least one redundant correlated feature variable from each of the one or more groups of correlated feature variables for obtaining a list of feature variables. The method further includes generating, by the processor, a plain-text explanation for the prediction score associated with the record based on the list of feature variables.

In another embodiment, an explanation generation system to generate plain text explanation for a prediction score is disclosed. The explanation generation system includes a memory and a processor. The memory includes stored instructions. The processor is configured to execute the stored instructions to cause the explanation generation system to perform at least in part to receive a record. The explanation generation system is caused to determine a plurality of feature variables contributing to the prediction score wherein the prediction score is computed by a Machine Learning (ML) model. The explanation generation system is further caused to rank the plurality of feature variables based at least on corresponding contribution of feature variables on the prediction score associated with the record. The explanation generation system is caused to determine one or more groups of correlated feature variables from among the plurality of feature variables. The explanation generation system is further caused to filter at least one redundant correlated feature variable from each of the one or more groups of correlated feature variables for obtaining a list of feature variables. The explanation generation system is further caused to generate a plain-text explanation for the prediction score associated with the record based on the list of feature variables.

Other aspects and example embodiments are provided in the drawings and the detailed description that follows.

### BRIEF DESCRIPTION OF THE FIGURES

For a more complete understanding of example embodiments of the present invention, reference is now made to the following descriptions taken in connection with the accompanying drawings in which:

FIG. 1 illustrates an example representation of an environment, related to at least some example embodiments of the present disclosure;

FIG. 2 is a block diagram of an explanation generation system enabling the generation of plain-text explanation for a prediction score associated with a record;

FIG. 3 is a process flow diagram illustrating the input-process-output of the method described herein, according to the embodiments as disclosed herein;

FIG. 4 illustrates a flow diagram of a method for facilitating the generation of plain-text explanation for a prediction score associated with a record;

FIG. 5 illustrates a flow diagram of a method to automatically generate plain-text sentences that provide an intuitive understanding of a prediction, according to the embodiments as disclosed herein; and

FIG. 6 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The term “feature variables” refers to factors in an input record, typically known as a feature variable that are both inputs used for prediction. These feature variables encode as much discriminatory information that allows us to measure their value to be able to predict with a high enough probability. The terms “feature variables”, “features” and “variables” are used interchangeably throughout the specification.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods, systems, user devices, and computer program products to generate a plain-text explanation associated with a prediction score computed by a Machine Learning (ML) model for a record. The system may include an explanation generation system that is configured to take input of a record and automatically generate plain-text explanation associated with a prediction score of the record, wherein the prediction score is computed using an ML model. The plain-text explanation includes the factors that affected the prediction score and feedback including steps to improve the prediction score. This is facilitated by first computing a prediction score for the record using a predictive Machine Learning (ML) model. The ML model may utilize any one or more algorithms present in a database to compute a prediction score for the record. The algorithms may include clustering algorithms, random forest method, Markov models, etc. that may be used to compute the prediction score. After the system computes the prediction score, the system is configured to determine a plurality of feature variables and a plurality of features that contribute to the prediction score. The feature variables may be factors that impact the prediction score computed by the system.

For example, if a record includes details associated with a person for the ML model to predict the life expectancy of the person, the explanation generation system may first predict the life expectancy using one or more Machine Learning algorithms. In an example embodiment, the record may include feature variables such as gender, age, health conditions, dietary habits, work-out frequency, blood test reports, surgery history, smoking frequency, drinking alcohol frequency, hereditary disease history in the family, etc.

Further, the explanation generation system is configured to rank the plurality of feature variables based on their contribution to the prediction score. Some of the feature variables may have a higher impact on the prediction score and some have less impact. Including all the feature variables in the plain-text explanation may be confusing for the user to understand. Therefore, the explanation generation system is configured to rank the plurality of feature variables based on their level of contribution to the prediction score associated with the record. For example, the explanation generation system may rank age, smoking habits, drinking habits, dietary habits, gender in the increasing orders of their rank, age having the highest-ranked feature variable and gender being the least.

In at least one embodiment, the system is configured to determine one or more groups of correlated feature variables from the plurality of feature variables. The system performs clustering of the feature variables which are highly correlated. A group is a cluster or set of feature variables that were meant to measure different characteristics and are influenced by some common mechanism and can vary together. For example, the above-mentioned feature variables may be clustered by the system using ML algorithms such as clustering or the like. The highly correlated features may be age-health conditions, gender-health conditions, hereditary disease history in the family-dietary habits, hereditary disease history in the family-smoking habits, etc. The system is configured to group the highly correlated feature variables to determine one or more groups of the correlated feature variables. For example, as mentioned above, age-health conditions, gender-health conditions may be determined as one group and hereditary disease history in the family-dietary habits, hereditary disease history in the family-smoking habits may be determined as another group.

Further, in one embodiment, the explanation generation system is configured to filter the groups of correlated feature variables to delete redundant correlated features. This is facilitated by using a basic filtering method or a correlation filtering method, Filtering methods are used to get rid of irrelevant, redundant data from a huge data set. For example, in the above mentioned groups of highly correlated feature variables i.e., age-health conditions, gender-health conditions, the explanation generation system may filter out gender-health conditions as age-health conditions are more important and the correlation value for age-health conditions contributed more to the prediction of life expectancy. In some embodiments, the explanation generation system may choose more than one correlated feature from a group of correlated features. It is exemplarily shown that only two feature variables are correlated. More than two feature variables may be correlated, and the explanation generation system is configured to group all the correlated feature variables and filter out the ones that are redundant and cause least error when discarded.

Further, in one embodiment, the explanation generation system is configured to determine a list of feature variables from the list of ranked feature variables in order to generate a simplified plain-text explanation. For example, the system may be configured to select one feature variable from each of the one or more groups of correlated feature variables and list them to determine a list of feature variables. The feature variable selected from each group may be the most impactful feature variable in the group of correlated feature variables.

In one example embodiment, a scenario analysis tool may be used to run “what if?” scenarios on the prediction score. The scenario analysis tool is configured to determine the resultant prediction score by changing the values of some feature variables. For example, the scenario analysis tool may reduce the value of smoking frequency of the user provided in the record and recompute the prediction score for the record. Similarly, the scenario analysis tool may change values of plurality of feature variables and determine the prediction score for the changed values.

Further, the explanation generation system is configured to determine the optimal value for one or more feature variables which will improve the prediction score. For, example if the life expectancy of a user based on the record provided by the user is predicted to be 56 years, the scenario analysis tool may determine that reducing smoking habit frequency by 80% and increasing work-out frequency by 25% will yield a life expectancy of 60 years. However, this analysis will be computed by the explanation generation system and will not be present in a plain-text format readable by the user.

The explanation generation system may use standardized libraries such as Local Interpretable Model-Agnostic Explanations (LIME) and SHapley Additive exPlanation (SHAP) to determine the prediction score corresponding to a changed value of at least one feature variable. LIME is a model-agnostic algorithm, implying that it can possibly be applied to any ML model. The method aims to comprehend the model by determining the contribution of each feature variable to the prediction score computed by the ML model.

SHAP measures the effect of a feature variable considering the correlation with another feature variable. SHAP computes the significance of a feature variable by contrasting what an ML model predicts with and without the feature variable. However, as the order in which the ML model considers the feature variables can affect its prediction scores, SHAP performs the computation in every possible permutation, so that all the feature variables are compared.

Further, to make the reasons for the prediction and steps to increase the prediction score into a readable intuitive format for the user, in at least one embodiment, the explanation generation system passes the output of the scenario analysis tool and the list of feature variables impacting the prediction score to a sentence creation module. The sentence creation module may parse the received input and cause the explanation generation system to further generate a plain-text explanation for the same. The plain-text explanation may be written in simple words understandable by the user. For example, the plain-text explanation for the above-given example would be “Life expectancy prediction for the record provided is 56 years. The smoking habit frequency of the user is 40% greater default-rate than the global average, the hereditary disease history in the family is 20% greater default-rate than average, surgery history is 2 which is equal to the global average. The user can increase the life expectancy to 60 years by reducing the smoking frequency by 80%”. The generated plain-text explanation may be displayed to the user on the display of the system.

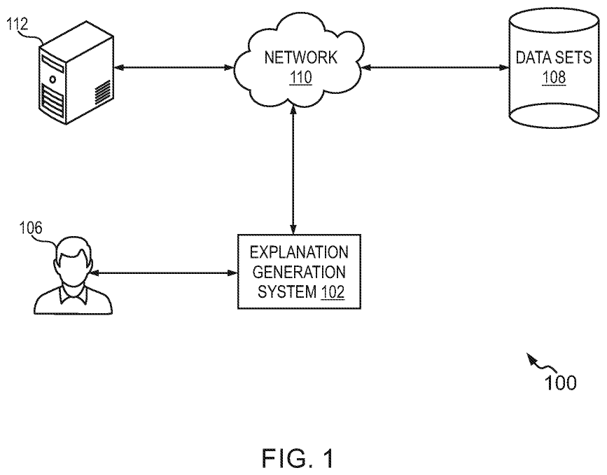

Various example embodiments of the present disclosure are described hereinafter with reference to FIGS. 1 to 6.

FIG. 1 illustrates an exemplary representation of a system 100 related to at least some example embodiments of the present disclosure. Although the system 100 is presented in one arrangement, other embodiments may include the parts of the system 100 (or other parts) arranged otherwise depending on, for example, computation of prediction scores, filtering groups of correlated feature variables, etc. The system 100 includes an explanation generation system 102, a user 106, data sets 108, a network 110, and a server 112. Examples of the network 110 include, but are not limited to, wireless network, wireline network, public network such as the Internet, Intranet, private network, General Packet Radio Network (GPRS), Local Area Network (LAN), Wide Area Network (WAN), Metropolitan Area Network (MAN), cellular network, Public Switched Telephone Network (PSTN), personal area network, and the like. The network 110 can be operable with cellular networks, Bluetooth networks, Wi-Fi networks, or any other networks or combination thereof.

The network 110 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, the network 110 may include multiple different networks, such as a private network made accessible by the explanation generation system 102 to the data sets 108 and, separately, a public network (e.g., the Internet, etc.) through which the explanation generation system 102 and the server 112 may communicate.

The explanation generation system 102 may be a stand-alone system or may be embedded in a portable electronic device or a desktop device configured with a user interface (not shown in FIG. 1) to interact with the user 106. Examples of the electronic device include, but are not limited to, a personal computer (PC), a mobile phone, a tablet device, a personal digital assistant (PDA), a smart phone and a laptop. Examples of the user interface include, but are not limited to display screen, keyboard, mouse, light pen, appearance of a desktop, illuminated characters and help messages.

The explanation generation system 102 is configured with a non-transitory computer-readable medium (an application program), the contents of which cause it to perform the method disclosed herein. Various modules are present in the processor of the explanation generation system 102. The modules facilitate a plurality of functionalities required to perform the method disclosed herein. The modules may utilize one or more data sets 108 that are required to perform certain functionalities.

The data sets 108 may be present at a remote database, cloud storage or the like. In some embodiments, the data sets 108 may be present locally in the memory of the explanation generation system 102. The data sets 108 may include a plurality of data such as sample data sets for ML algorithms, global variable statistics, etc.

The user 106 may be an individual consumer or risk-teams of an institution. The user 106 may input a record to the explanation generation system 102 presented with simple plain-text sentences that provide an intuitive understanding of the prediction. The sentence outputs are optimized for intuitiveness and simplicity. The server 112 is responsible and dedicated to managing the network resources.

In an example embodiment, the explanation generation system 102 is configured to receive a record as an input from the user 106. The user 106 may input the record on a display of the explanation generation system 102. The record herein is provided by the user 106 to check a prediction score associated with the record. The explanation generation system 102 is configured to compute a prediction score and generate a plain text explanation including the feature variables and their impacts on the prediction score. In another example embodiment, the explanation generation system 102 is configured to generate a plain-text explanation for the steps to increase the prediction score as well.

A plurality of ML models and algorithms are used by the explanation generation system 102 to perform one or more operations described herein. The explanation generation system 102 may also utilize a plurality of data sets 108 to train and execute the ML models. In an embodiment, the received record may be pre-processed by the explanation generation system 102. Pre-processing includes computing a prediction score associated with the record using an ML model with which the user 106 may have checked the prediction score previously. In such scenarios, the user 106 may also input the ML model which was used by him/her to compute the prediction score. Further, the explanation generation system 102 is configured to pre-process the record to find out the prediction score for the record using the same ML model. The prediction may be performed by one or more ML algorithms such as random forest model, Markov model, etc.

Further, in another embodiment, the explanation generation system 102 is configured to determine a plurality of feature variables in the record that contribute to the prediction score computed using the ML model. A plurality of feature variables may be impacting the prediction score in the ML model. The explanation generator module is configured to determine all such feature variables and rank the plurality of the feature variables based on their level of impact. The higher is the impact of the feature variable on the prediction score, the better is the allocated rank to the feature variable. The feature variable with the topmost rank impacts the prediction score the highest and the one with the least rank impacts the prediction score the least.

In one example embodiment, after the plurality of feature variables are rank-ordered, the explanation generation system 102 is further configured to determine one or more groups of highly correlated feature variables of the plurality of feature variables. Correlated feature variables are one or more feature variables configured to measure different factors but may be related to one another such that change in one feature variable may vary another feature variable. Such feature variables are determined by the explanation generation system 102 using one or more algorithms stored in the memory. In some alternate embodiments, the algorithms may present in remote databases such as data sets 108. The explanation generation system 102 may utilize the algorithms present in the data sets 108 to perform operations.

After one or more groups are determined for correlated features, the explanation generation system 102 is further configured to filter out the similar and/or redundant feature variables from one or more groups of the correlated feature variables. In an example embodiment, a list of feature variables is determined out of the plurality of groups of correlated feature variables. One feature variable may be determined from each of the one or more groups of correlated feature variables. Filtering may be performed by utilizing any available filtering techniques. Filtering facilitates getting rid of feature variables which may be irrelevant to the user and which may cause comparatively less impact on the prediction score and the correlation.

Further, in an example embodiment, the explanation generation system 102 is configured to determine a list of feature variables based on the filtering process. At least one feature variable from each of the one or more groups of correlated feature variables is selected based on the filtering. The most influential feature variable may be selected from each group. All the retrieved feature variables from each group may be listed and a list of feature variables may be determined by the explanation generation system 102. The list of feature variables may be further passed to the sentence creation module. The list of feature variables may be included in the plain text explanation output by the explanation generation system 102. Other feature variables may not be considered by the explanation generation system 102 in generating the plain-text.

Further, in an example embodiment, the explanation generation system 102 is configured to generate a plain-text explanation for the record based on the list of feature variables and their values associated with the record provided by the user 106 compared with a global statistics associated with the feature variables. The explanation generation system 102 may first pass the feature variables and their impacts on the prediction score to a sentence parser. The sentence parser may parse the feature variables and values. A sentence creation model may be utilized by the explanation generation system 102 to generate plain-text explanations of the prediction score associated with the record. The sentence creation model may be configured to use various data from the data sets 108 such as word dictionary, global variable statistics and the like to process and generate the output in the form of a plain-text explanation. The generated plain-text explanation may be displayed to the user 106 on the display of the explanation generation system 102.

In one example embodiment, the explanation generation system 102 may be configured to pass the determined list of feature variables to a scenario analysis tool. The scenario analysis tool is a model present in the processor of the explanation generation system 102. The scenario analysis tool is configured to determine an optimal value for at least one feature variable.

It is assumed that a Machine Learning (ML) model is used to generate predictions. To generate the explanations for a record, the record is pre-processed. Subsequently, the record is run through an explanation generating algorithm which gives a list of variables. The variables are rank-ordered based on their impact on the prediction. Similar correlated features are then filtered. The remaining features are run through a scenario-analysis tool to find the impact of changing the variables on the final score. Finally, the important variables and outputs of the scenario analysis are passed to a parser which turns the raw output into a readable and intuitive sentence for the user to understand.

It should be appreciated by those of ordinary skill in the art that FIG. 1 depicts the explanation generation system 102 in an oversimplified manner and a practical embodiment may include additional components and suitably configure processing logic to support known or conventional operating features that are not described in detail herein.

In an alternate embodiment, some of the components present in the explanation generation system 102 may be performed by the server 112. The explanation generation tool may be configured to send and receive data from server 112 over the network 110. APIs may be implemented in the explanation generation system 102 to invoke components present in the server 112. The server 112 may be configured to perform all the operations that the explanation generation system 102 is configured to perform. The server 112 may be configured to send the output back to the explanation generation system 102 to display it to the user 106.

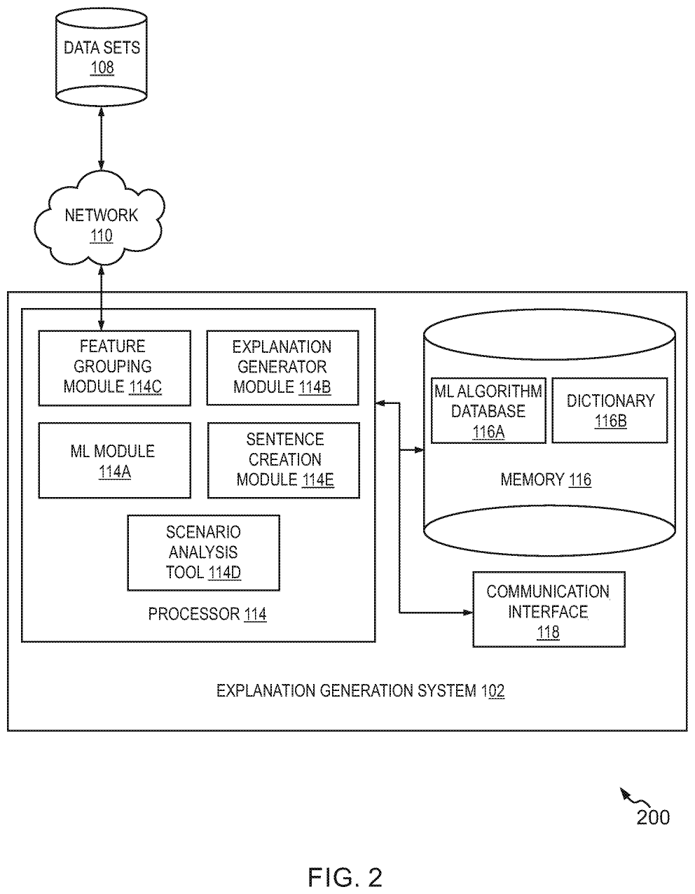

Now, turning to FIG. 2 illustrates a simplified block diagram 200 including an explanation generation system 102, data sets 108 and a network 110. The explanation generation system 102 includes processor 114, memory 116 and a communication interface 118. The processor 114 includes one or more modules/engines which enable the explanation generation system 102 to perform operations disclosed herein. The processor 114 may include an ML module 114a which enables the execution of a plurality of ML models and/or ML algorithms such as clustering algorithms, filtering algorithms, Regression algorithms, etc. These algorithms may be stored in memory 116 and utilized by the ML module 114a to perform plurality of operations disclosed herein. The processor 114 may further include an explanation generator module 114b, a feature grouping module 114c, a scenario analysis tool 114d and a sentence creation module 114e.

The memory 116 may have a plurality of databases stored. In an embodiment, the memory 116 may include ML algorithm database 116a and a dictionary 116b, the dictionary 116b may include words and context-free grammar for the English language. The processor 114 is operatively coupled to a communication interface 118 such that explanation generation system 102 is capable of communicating with one or more remote servers or databases such as data sets 108 or communicating with any entity within the explanation generation system 102.

This setup of components and server systems may be utilized to facilitate the generation of plain-text explanation for a prediction score associated with a record input by the user 106. The plain-text explanation may include readable intuitive sentences explaining about plurality of variables contributing to the prediction score associated with the record, how more/less is the value of a variable from a global average for that variable etc. In some additional embodiments, the plain-text explanation may also include an easy-to-read, intuitive explanation of an optimal change in a value for a variable that will improve/maximize the prediction score.

In an example embodiment, the user 106 may input a record to the explanation generation system 102. The record may include values for a plurality of variables required for the computation of a prediction score by the ML module 114a. For example, the user 106 may want a plain text explanation of a life expectancy predicted by an ML model. The user 106 may want to know the reasons that impacted his/her predicted life expectancy and may want to know about steps that would improve the life expectancy of the user 106. The record input by the user 106 may be “Age: 32, Gender: Male, smoking frequency: 5 cigarettes per day, alcohol intake rate: 90 ml every two days, Number of surgeries undergone: 1, sleeping hours per day: 5, hereditary disease history in the family: Yes”.

The ML module 114a of the explanation generation system 102 may pre-process the record using an ML model such as random forest method, Markov Model and/or neural network models and the like, which may be stored in the ML algorithm database 116a of the memory 116 to compute a prediction regarding the life expectancy of the user 106. For example, the ML module 114a may determine the life expectancy to be 53 Years based on the values of the feature variables provided by the user 106 in the record. This may be computed using a trained predictive ML module.

Further, in an example embodiment, the explanation generator module 114b is configured to determine a plurality of feature variables contributing to the prediction score i.e., the predicted life expectancy of the user 106. The explanation generator module 114b may use algorithms such as LIME or SHAP to determine a plurality of feature variables that have an impact on the predicted life expectancy. For example, the example generation module may determine Age, Gender, smoking frequency, alcohol intake rate, Number of surgeries undergone, sleeping hours per day, and hereditary disease history in the family as the feature variables that are contributing to the life expectancy prediction.

The explanation generator module 114b is further configured to rank order the feature variables based on their level of contribution to the prediction score. LIME and SHAP models may be used to rank order the feature variables. In the example, the order of feature variables based on their level of contribution may be smoking frequency, alcohol intake rate, Age, sleeping hours per day, hereditary disease history the family, gender and number of surgeries undergone. The explanation generator module 114b may rank the feature variables accordingly by running these feature variables through a LIME or SHAP model.

In one example embodiments, a feature grouping module 114c is configured to determine groups of correlated feature variables from the plurality of feature variables. It frequently happens that two feature variables that were intended to quantify various qualities are affected by another common feature and will change together. For instance, the perimeter and the maximum width of a figure will both change with scale. Therefore, bigger figures will have both bigger perimeters and bigger maximum widths. The feature grouping module 114c is configured to group highly correlated features in the plurality of feature variables.

One or more groups may be determined by the feature grouping module 114c. For example, in the record provided by the user 106, one group determined by the feature grouping module 114c may be smoking frequency, age, alcohol intake rate, gender, sleeping hours per day. These may be determined to be correlated feature variables and grouped by the feature grouping module 114c. Similarly, more groups may be determined by the feature grouping module 114c.

Furthermore, the feature grouping module 114c is configured to remove the correlated feature variables that would accumulate in the explanation outputs. In other words, the user does not get overloaded with similar correlated feature variables. The feature grouping module 114c is configured to filter out the redundant or irrelevant feature variables from each group. The filtering may result in getting rid of similar feature variables in the group and to take out feature variables whose absence would cause the least error to the correlation. In the example, the feature variable ‘smoking frequency’ may be selected by the feature grouping module 114c after the filtering process in performed.

Hence, redundant information is discarded and only the most influential feature variable from each group is selected. The result is the top 3-10 variables that are presented to the user. It must be noted that the said number of variables is arbitrary and may be subjected to any appropriate number. However, it is best recommended to keep the list of variables short to make it more actionable. In the example smoking frequency, alcohol intake and sleeping hours per day may be determined to be the most impactful feature variables. These variables may be listed and a list of feature variables from the one more groups is retrieved. The feature variables in the list of feature variables will be included in the plain text explanation further.

Further, in an example embodiment, a scenario analysis tool 114d is developed and implemented in the explanation generation system. This scenario analysis tool 114d is configured to run “what if” scenarios on Machine learning models to determine outputs of the ML models by changing values of the feature variables. In the example, the scenario analysis tool 114d may run “what if” scenarios on the predictive ML model which will be used to compute the prediction score i.e., the life expectancy. The scenario analysis tool 114d is further configured to determine an optimal change in a value of a feature variable that will improve/maximize the life expectancy of the user 106. The scenario analysis tool 114d may determine that reducing the smoking frequency by 78%, will result in the life expectancy of the user 106 to be 62 years for corresponding ML model.

Further, in one embodiment, the list of feature variables and the output of the scenario analysis tool 114d may be passed to a sentence creation module 114e. The sentence creation module 114e may be configured to utilize variable statistics from the data sets 108 and the dictionary 116b from the memory 116 and generate a plain text explanation regarding the prediction score associated with the record. Various variable statistics may be compared with the values of variables input by the user 106 and the output of the scenario analysis tool 114d may be parsed by the sentence creation module 114e. Further after parsing, an easy-to-read intuitive sentence regarding the results may be generated. In the example, the sentence creation module 114e based on the list of feature variables and the output of scenario analysis tool 114d may generate a plain-text explanation “Your life expectancy is predicted to be 53 Years. Your smoking frequency is 30% greater than the global average, alcohol intake is 29% greater than the global average and the number of sleeping hours is 48% lesser than the global average. You have to reduce your smoking frequency by 78% to increase your life expectancy to 62 Years”.

Further, the generated plain-text explanation may be displayed to the user 106 on the display of the explanation generation system or on the display of a computing device that the explanation generation system is implemented on.

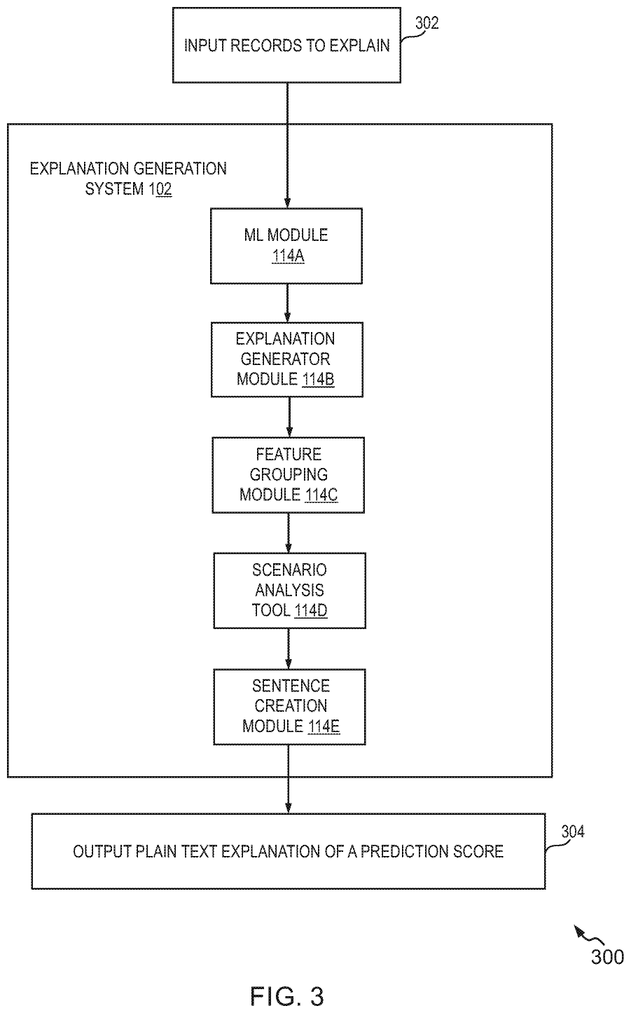

FIG. 3 is a process flow diagram illustrating the input-process-output of a method 300 related to embodiments disclosed herein. The method 300 is described with the system components of the explanation generation system 102. The explanation generation system 102 may include an ML module 114a, an explanation generator module 114b, a feature grouping module 114c, a scenario analysis tool 114d, and a sentence creation module 114e. The system is also shown including a memory 116. The memory 116 includes an ML algorithm database 116a. These algorithms may be used alone or in combination to perform the various operation of the embodiments disclosed herein.

An input 302 may be received by the explanation generation system 102. The input 302 may include record for which a plain-text explanation has to be generated by the explanation generation system 102. This record may be pre-scored using an ML model to get a prediction score associated with the record. The prediction score may be computed using any predictive ML algorithms such as decision tree, random forest, Regression models, etc. The user would send an original record to the explanation generation system and in some embodiments, the user may as well input an ML model with which he/she has pre-scored the record.

After the input is received, the explanation generation system 102 may pre-process the record using a predictive ML model. The pre-processing includes computing a prediction score associated with the record. The explanation generation system 102 is configured to generate a plain-text explanation for the prediction score. The plain text may include feature variables and their impacts on the prediction scores and in some embodiments, steps to improve the prediction score may be explained by the explanation generation system 102 in easy-to-read, intuitive sentences.

After the ML module 114a computes the prediction score, the explanation generator module 114b is configured to determine a plurality of feature variables that contribute to the prediction score. Explanation generator module 114b may use feature detection models such as LIME and/or SHAP to detect the plurality of feature variables that have an impact on the prediction score. After the explanation generator module 114b has determined the plurality of feature variables that impact the prediction score, the explanation generator module 114b is configured to rank the plurality of feature variables based on the contribution of each feature variable on the prediction score. The greater the impact of a feature variable on the prediction score, the higher is its rank. Accordingly, the feature variable with the highest contribution to the prediction score will have the topmost rank and the one with the least contribution will have a lowermost rank.

Further, after the feature variables are rank-ordered by the explanation generator module 114b, a feature grouping module 114c is configured to determine one or more groups of correlated feature variables from the plurality of feature variables. The correlated feature variables are the variables that have a correlation between one another i.e., a change in one variable may change the value of another variable. Some correlations may be positive and some may be negative. The correlated feature variables may be grouped based on their correlation. Highly correlated feature variables are determined and grouped into one or more groupings. In an example embodiment, 4-5 groups of highly correlated features may be determined by the feature grouping module 114c.

In one example embodiment, after the feature variables are grouped into one or more groups of correlated feature variables, the groups are filtered to get rid of redundant and irrelevant feature variables. Filtering the groups may be performed by a standard filtering algorithm. The algorithm may take the input of groups of correlated feature variables and may get rid of feature variables that are redundant, and would have a least impact on the correlation. The feature variables with the least impact on the correlation may be discarded from the group. At least one feature variable is selected from each of the one or more groups based on the level of its contribution on the prediction score. All the retrieved feature variables from one or more groups are listed. This operation results in a list of filtered feature variables.

After the feature filtering process, scenarios such as “why?” can be formulated as a counterfactual and run through a scenario analysis tool 114d. For example, if a life expectancy prediction score has been computed to be 56 years and said that the user is at high risk, the scenario analysis tool may run the counterfactual to determine the reasons for the prediction and in some embodiments, this tool may utilize LIME and/or SHAP algorithms to determine an optimal value for at least one feature variable that would improve or maximize the prediction score.

Further, the output of the scenario analysis tool and the list of feature variables may be passed to a sentence creation module 114e. The sentence creation module 114e may utilize the output from the scenario analysis tool 114d and a plurality of variable statistics to generate plain text explanations 304 for the prediction score associated with the record, the variable statistics may be retrieved from a remote database such as data sets 108. These statistics may be compared with the values of the feature variables present in the record and the results may be included in the plain-text explanation. In some scenarios where an optimal value for a feature variable that may maximize or improve the prediction score is determined, the plain text explanations 304 may also include a plain-text explanation about the optimal value for a feature variable in easy-to-read, understandable sentences.

In some alternate embodiments, the scenario analysis tool 114d may only select a pre-defined number of feature variables from the list of feature variables to determine the counterfactual scenarios and may determine the outputs. For example, a list of feature variables for the prediction score associated with a life expectancy of the user may be determine to be age, smoking frequency, alcohol intake rate, gender, and surgery history. Here, the scenario analysis tool may only choose 2-3 feature variables from the list based on their ranks determined by the explanation generator module 114b. Therefore, in the example embodiment, the scenario analysis tool 114d may select only age, smoking frequency and alcohol intake rate to run counterfactual scenarios.

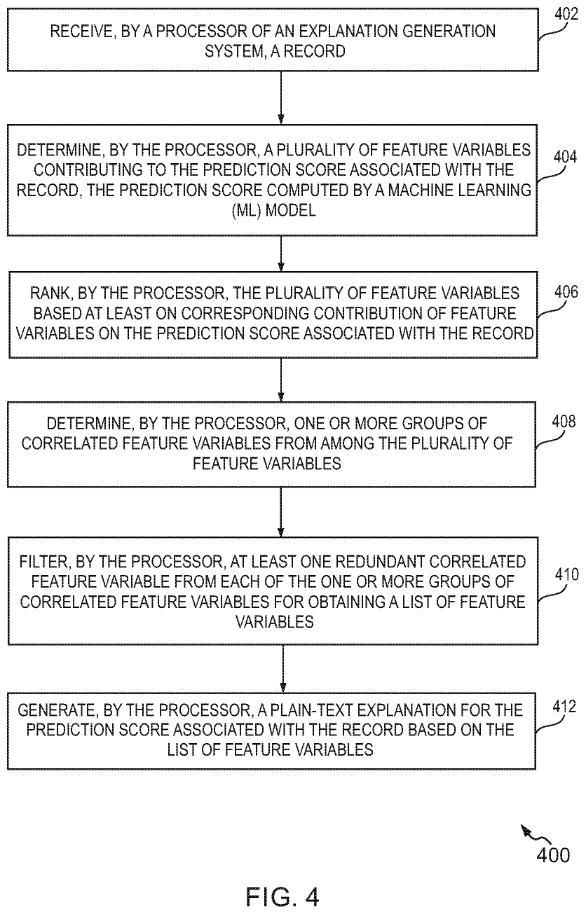

Now, referring to FIG. 4 illustrates a flow diagram of a method for facilitating the generation of plain-text explanation for a prediction score associated with a record, by the explanation generation system 102, in accordance with an example embodiment. The method 400 depicted in the flow diagram may be executed by, for example, a system such as the explanation generation system 102. Operations of the method 400, and combinations of operation in the method 400, may be implemented by, for example, hardware, firmware, a processor, circuitry and/or a different device associated with the execution of software that includes one or more computer program instructions. The method 400 starts at operation 402.

At 402, the method 400 includes receiving, by the processor 114 of an explanation generation system 102, a record. The record may be an original record provided by the user 106 of FIG. 1 to an ML model for computing a prediction score associated with the record. The record may include a plurality of variables which would be considered by the ML model for the prediction score computation. In an example embodiment, the user 106 may input a record with age, gender, smoking habit frequency, alcohol habit frequency, hereditary diseases history in the family to the explanation generation system 102 to get a life expectancy prediction and a plain-text explanation based on an ML model, a plain text explanation of the feature variables impacting the prediction score and steps to improve the prediction score.

At 404, the method 400 includes, determining, by the processor 114, a plurality of feature variables contributing to the prediction score wherein the prediction score is computed using an ML model. At this step, the method includes finding out a plurality of feature variables which contribute to the prediction score associated with the record. An explanation generator module 114b is configured to utilize one or more algorithms such as LIME and/or SHAP models stored in the memory 116 to determine a plurality of feature variables that are contributing to the prediction score.

At 406, the method 400 includes ranking, by the processor 114, the plurality of feature variables based at least on corresponding contribution of feature variables on the prediction score associated with the record. The processor 114 is configured to rank the feature variables based on their level of impact on the prediction score. The explanation generator module 114b present in the processor 114 is configured to utilize one or more ML algorithms present in the memory 116 of the explanation generation system 102. The feature variables may be ranked in an increasing order of their level of impact on the prediction score. The higher the contribution of the feature variable on the prediction, better is the rank of the feature variable determined by the processor 114.

At 408, the method 400 includes, determining, by the processor 114, one or more groups of correlated feature variables from among the plurality of feature variables. A feature grouping module 114c present in the processor 114 of the explanation generation system 102 is configured to group highly correlated feature variables. The plurality of variables determined and ranked by the explanation generator module 114b may be further passed to the feature grouping module 114c. The feature grouping module 114c may determine a plurality of features which are correlated using one or more algorithms present in the memory 116. The correlated features are further, grouped by the feature grouping module 114c. A plurality of groupings may be determined by the feature grouping module 114c.

At 410, the method 400 includes, filtering, by the processor 114, at least one redundant correlated feature variable from each of the one or more groups of correlated feature variables for obtaining a list of feature variables. The feature grouping module 114c is further configured to filter out one or more irrelevant or redundant feature variables from the group of related feature variables. The filtering may be carried out by any available filtering method. Redundant and least contributing feature variables may be filtered out from each of the groups determined by the processor. This results in determining 1-2 feature variables from each group. A list of feature variables is obtained after the filtering is done.

At 412, the method 400 includes, generating, by the processor 114, a plain-text explanation for the prediction score associated with the record based on the list of feature variables. The sentence creation module 114e is configured to parse the pre-defined number of feature variables and their impacts on the prediction to produce a readable plain-text explanation for the prediction score associated with the record. The plain text explanation may include intuitive sentences regarding the prediction score, the list of feature variables and their impacts on the prediction score compared with the global averages of the corresponding feature variables.

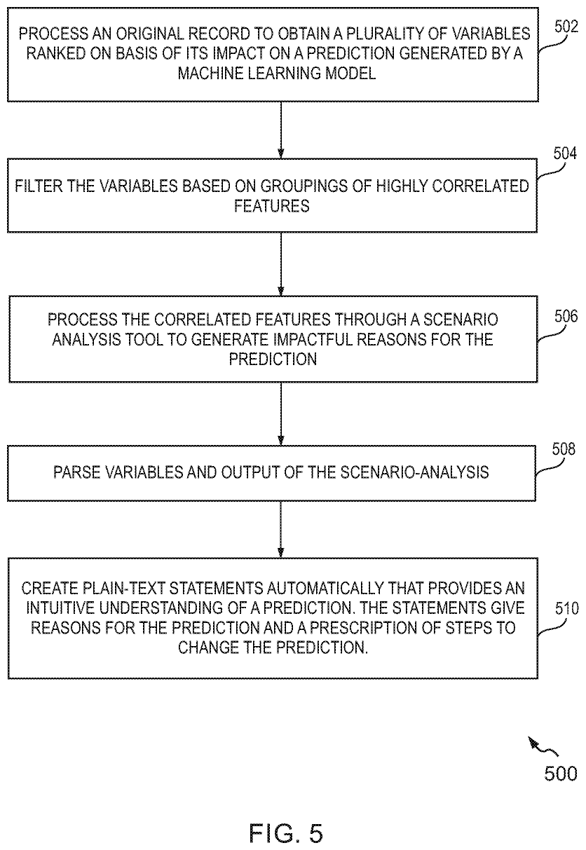

Now, referring to FIG. 5 illustrates a method to automatically generate plain-text sentences that provide an intuitive understanding of a prediction, according to the embodiments as disclosed herein. The method 500 depicted in the flow diagram may be executed by, for example, a system such as the explanation generation system 102. Operations of the method 500, and combinations of operation in the method 500, may be implemented by, for example, hardware, firmware, a processor, circuitry and/or a different device associated with the execution of software that includes one or more computer program instructions. The method 500 starts at operation 502.

At step 502, an original record is processed to obtain a plurality of variables ranked on the basis of their impact on a prediction generated by a machine learning model. The original record is one that has been already scored but requires intuitive explanations. This record is pre-processed using the same code base as scoring. The record is then run through an appropriate explanation generator, such as LIME, SHAP or a similar hand-crafted solution. The explanation generator produces a rank-ordered list of variables and their impact on the model prediction. Typically, most of these explanation generators require access to the predictive model.

At step 504, the variables are filtered based on groupings of highly correlated features. Only one feature from each grouping is retained. Highly correlated features carry similar information and are normally a burden to the user. Hence, this redundant information is discarded and only the most influential variable from each group is selected. The result is the top 3-10 variables that are presented to the user. It must be noted that the said number of variables is arbitrary and may be subjected to any appropriate number. However, it is best recommended to keep the list of variables short to make it more actionable. The grouping of variables is performed prior to running the explanations. This may be done in several ways, for instance, using correlation coefficients, PCA or manual grouping.

At step 506, the correlated features are processed through a scenario-analysis tool to generate impactful reasons for the prediction. The selected variables are run through the scenario-analysis tool. This tool re-scores the record multiple times using typical values from a sample dataset. For each variable, the change that results in the maximum change in score is obtained. This requires information from historical data either by sampling or by storing the statistical information.

At step 508, the variables and output of the scenario-analysis are parsed. Each variable is parsed into a readable sentence. Variable names are parsed out and a lookup table is used (if required) to find the correct wording. The variable value is transformed into a population percentile to ease interpretation.

At step 510, plain-text statements that provide an intuitive understanding of a prediction are automatically created. The statements give reasons for the prediction and a prescription of steps to change the prediction.

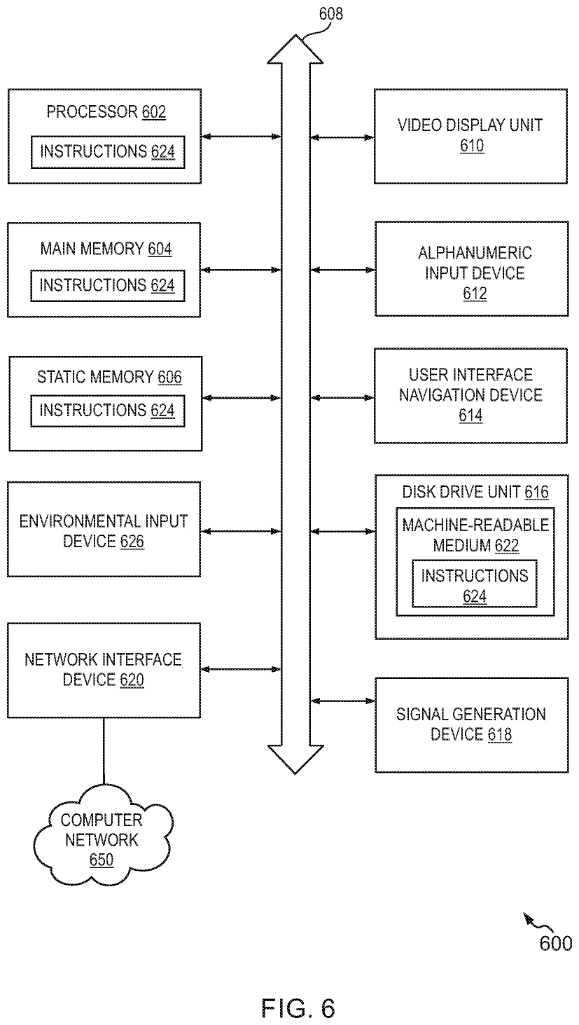

FIG. 6 is a simplified block diagram of a machine in the example form of a computer system 600 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker), and a network interface device 620. The computer system 600 may also include an environmental input device 626 that may provide a number of inputs describing the environment in which the computer system 600 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 624 may further be transmitted or received over a computer network 650 using a transmission medium. The instructions 624 may be transmitted using the network interface device 620 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, Java, Swift and Objective C. The computer software product can be an independent application with data input and data display modules. Alternatively, the computer software products can be classes that can be instantiated as distributed objects. The computer software products can also be component software, for example, Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example, Wi-Fi (IEEE standard 802.11 including its substandard a, b, e, g, h, i, n, et al.). In one example, signals from the computer can be transferred, at least in part, wirelessly to components or other computers.

Various embodiments of the present disclosure offer multiple advantages and technical effects. For instance, the present disclosure facilitates generation of a plain-text explanation for a prediction score associated with a record provided by the user. The prediction score is computed by a ML model. Several mathematical and algorithmic techniques discover one particular characteristic of interpreting the underlining machine learning model, however, each of these methods has significant disadvantages. The present disclosure aims in creating an explanation generation system that takes a collection of these mathematical approaches, aggregates them into a set of natural language statements explaining permutation feature importance, feature interaction, top counterfactuals, and the magnitude of feature attributions, and combines them in natural language based responses. In addition, the explanation generation system facilitates testing of a variety of counterfactual scenarios giving us a method to prescribe mitigations to the users based on our model predictions.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Accordingly, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer-readable media as computer program products. Any form of computer-readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a processor of an explanation generation system, a record;
determining, by the processor, a plurality of feature variables contributing to a prediction score associated with the record, the prediction score computed by a Machine Learning (ML) model;
ranking, by the processor, the plurality of feature variables based at least on corresponding contribution of feature variables on the prediction score associated with the record;
determining, by the processor, one or more groups of correlated feature variables from among the plurality of feature variables;
filtering, by the processor, at least one redundant correlated feature variable from each of the one or more groups of correlated feature variables for determining a list of feature variables; and
generating, by the processor, a plain-text explanation for the prediction score associated with the record based on the list of feature variables.

2. The method as claimed in claim 1, wherein generating the plain-text explanation comprises:
parsing, by the processor, the determined list of feature variables; and
generating, by the processor, the plain-text explanation based on the parsing.

3. The method as claimed in claim 1, further comprising:
displaying the plain-text explanation on a display of the explanation generation system.

4. The method as claimed in claim 1, further comprising:
determining, by the processor, using a scenario analysis tool, an optimal value for at least one feature variable from the list of feature variables that maximizes the prediction score.

5. The method as claimed in claim 4, wherein determining the optimal value for the at least one feature variable comprises:
calculating, by the processor, impacts of the plurality of feature variables on the prediction score, by changing values of the plurality of feature variables; and
re-computing, by the processor, the prediction score for the changed values.

6. The method as claimed in claim 5, wherein Local Interpretable Model-Agnostic Explanations (LIME) and SHapley Additive ex-Planation (SHAP) are used to determine the impacts of the plurality of feature variables on the prediction score.

7. The method as claimed in claim 1, wherein the plain-text explanation comprises an optimal value for at least one feature variable from the list of feature variables which will maximize the prediction score.

8. The method as claimed in claim 1, wherein receiving the record comprises receiving the ML model used to pre-score the record.

9. The method as claimed in claim 8, wherein same predictive ML model used to pre-score the record is utilized to compute the prediction score.

10. An explanation generation system for generating plain-text explanation, the explanation generation system comprising:
a memory comprising executable instructions; and
a processor communicably coupled to a communication interface, the processor configured to execute the executable instructions to cause the explanation generation system to at least:
receive a record;
determine a plurality of feature variables contributing to a prediction score, the prediction score computed by a Machine Learning (ML) model;
rank the plurality of feature variables based at least on corresponding contribution of feature variables on the prediction score associated with the record;
determine one or more groups of correlated feature variables from among the plurality of feature variables;
filter at least one redundant correlated feature variable from each of the one or more groups of the correlated feature variables for determining a list of feature variables; and
generate a plain-text explanation for the prediction score associated with the record based on the list of feature variables.

11. The system as claimed in claim 10, wherein the system is further caused to:
parse, by the processor, the determined list of feature variables; and
generate, by the processor the plain-text explanation based on the parsing.

12. The system as claimed in claim 10, the system is further caused to display the plain-text explanation on the display of the explanation generation system.

13. The system as claimed in claim 10, wherein the system is further caused to:
determine, by the processor, using a scenario analysis tool, an optimal value for at least one feature variable from the list of feature variables that maximizes the prediction score.

14. The system as claimed in claim 13, wherein the system is further caused to:
calculate, by the processor, impacts of the plurality of feature variables on the prediction score, by changing values of the plurality of feature variables; and
re-compute, by the processor, the prediction score for the changed values.

15. The system as claimed in claim 14, wherein Local Interpretable Model-Agnostic Explanations (LIME) and SHapley Additive ex-Planation (SHAP) are used to determine the impacts of the plurality of feature variables on the prediction score.

16. The system as claimed in claim 10, wherein the plain-text explanation comprises an optimal value for at least one feature variable from the list of feature variables which will maximize the prediction score.

17. The system as claimed in claim 10, wherein the system is further caused to:
receive, by the processor, the ML model used to pre-score the record.

18. The system as claimed in claim 17, wherein same predictive ML model used to pre-score the record is utilized to compute the prediction score.
